(19) United States
(12) Patent Application Publication
(10) Pub. No.: US 2014/0360458 A1
(43) Pub. Date: Dec. 11, 2014

(54) INTERNAL COMBUSTION ENGINE WITH PAIRED, PARALLEL, OFFSET PISTONS

(71) Applicants: Allen Cocanougher, North Richland Hills, TX (US); Robert Allen Cocanougher, Keller, TX (US)

(72) Inventors: Allen Cocanougher, North Richland Hills, TX (US); Robert Allen Cocanougher, Keller, TX (US)

(21) Appl. No.: 14/282,201

(22) Filed: May 20, 2014

Related U.S. Application Data
(60) Provisional application No. 61/831,491, filed on Jun. 5, 2013.

(51) Int. Cl. F02B 75/18

(52) U.S. Cl. CPC F02B 75/1896
USPC 123/27 R; 123/51 A; 29/888.011

(57) ABSTRACT

An internal combustion engine; wherein at least two cylinders continuously communicate via the cylinder head; and wherein the connecting rod in one cylinder is offset from the connecting rod in the second cylinder by an angle between 1 and 90 degrees as measured from the crankshaft.

### CROSS-REFERENCE TO RELATED APPLICATION

This application claims priority to U.S. provisional application Ser. No. 61/831,491 filed Jun. 18, 2013, which is incorporated herein by reference in its entirety.

### FIELD OF INVENTION

The present application is generally related to internal combustion engines. More specifically, the present invention relates to a four-stroke engine having a pair of connecting rods, which are offset at an offset angle as measured from the crankshaft, and having at least two cylinders that communicate via a common cylinder head.

### BACKGROUND OF THE INVENTION

Internal combustion engines are devices in which reactants (e.g., fuel and an oxidizer) are combusted in a combustion chamber to produce high-pressure gas so as to apply force to another component of the engine. The typical components of an internal combustion engine are well known to those of ordinary skill in the art. These components generally include cylinders, pistons, valves, the cylinder head, the crankshaft, the camshaft, and the engine block.

Combustion of the reactants takes place inside a combustion chamber, which is generally formed by the cylinder heads, cylinders, and the tops of the pistons. In spark ignition engines, a spark is used to ignite the reactants. In compression ignition engines, the heat created by compression ignites the reactants. Regardless of how the reactants are ignited, the resulting combustion produces heat and pressure that act on the moving surfaces of the engine, such as the top of the piston. The pistons are generally attached to a crankshaft via connecting rods, which transfer the motion of the pistons into rotational motion.

Most internal-combustion engines are four-stroke engines. A four-stroke engine is one in which the piston(s) must complete four movements, or strokes, to produce power. This is also known as the “Otto” cycle. Typically, a four-stroke engine works as follows. During the first stroke, intake, the piston descends, drawing the reactants into the combustion chamber through an inlet valve. The piston continues downward until it reaches the point at which it is farthest from the cylinder head, i.e., bottom dead center. At the start of the second stroke, compression, the inlet valve closes, and the piston moves upward to the point where it is closest to the cylinder head, i.e., top dead center. In the third stroke, power, the compressed reactants are ignited, forcing the piston downward. An outlet valve opens and the piston moves back upward to complete the last stroke, exhaust. The four-stroke cycle is then repeated.

A commonly cited problem with the four-stroke engine is that it operates at only one-third efficiency. In other words, only a third of the potential fuel energy is delivered to the crankshaft. Two thirds of the energy is lost either through the exhaust or as waste heat. Thus, due in part to increased fuel-efficiency standards, numerous variations have been introduced to improve engine efficiency. See U.S. Pat. Nos. 8,434,305, 8,347,850, 7,810,459, 6,543,225, 4,776,306, 4,099,489, 3,871,337, 2,988,065, 2,058,705, 1,790,534, and 608,845; WO Pubs. 2005068812, 2004027237; EP Pubs 1,148,219, 1,170,478, 1,312,778, 1,607,594, 1,895,138, 2,088,283; and David Scott, “Paired-Cylinder Engine,” Popular Science February 1978. Each and every reference cited herein is hereby incorporated by reference in its entirety, where appropriate, for teachings of additional or alternative details, features, and/or technical background.

One alternative to the traditional four-cycle engine is the split-cycle engine, in which the four strokes are shared between two cylinders. In a split-cycle engine, the intake and compression strokes take place in one cylinder. The compressed reactants are then transferred to a second cylinder, in which the power and exhaust strokes are performed. Transference between the first and second cylinder typically occurs via a crossover chamber, which is closed off via a valve before ignition in the second cylinder. Outside of split-cycle engines, communication of the reactants between two cylinders is uncommon in engine design.

The Scott article, cited above, describes a pair of pistons connected by a recess in the block face, where the pistons perform separate “mixture-induction” and “air-swirl” functions. However, this design causes additional cost and efficiency problems. For example, while the cylinder head is easily replaceable, the block face is not. One advantage of the current invention is that it can be created from existing engines efficiently and inexpensively by modifying the cylinder head and the crankshaft or connecting rods.

Traditionally, ignition is timed so that combustion occurs near the end of the compression stroke, i.e., slightly before top dead center. This is needed because the reactants do not completely burn at the moment that the spark fires. Thus, by advancing the spark before top dead center, combustion actually occurs when the combustion chamber reaches its minimum size. Generally, sparks occurring after top dead center are thought to be counter-productive, producing excess waste. Only a few small engines are designed to ignite after top dead center.

Knocking is another engine complication that occurs when the reactants are unintentionally combusted at the incorrect moment. Knocking can cause severe engine damage. In a spark ignition engine, the reactants are meant to be ignited only via the spark plug at the precise time of ignition. Knocking, or abnormal combustion, occurs when a pocket of the reactants are detonated outside the boundary of the flame front. Knocking can be caused by pre-ignition, when the reactants ignite before the spark plug fires.

The prior-art engines discussed herein are to be considered conventional engines where appropriate.

### SUMMARY OF THE INVENTION

An embodiment of the invention comprises a new and improved internal combustion engine comprising a cylinder head, a first and second cylinder, a first and second piston, a first and second connecting rod, and a crank shaft, wherein the first and second cylinder communicate via the cylinder head, which remains open at all times, and wherein the second connecting rod is offset from the first connecting rod at an offset angle between about 1 and 90 degrees.

An internal combustion engine comprising: a cylinder head, a first and second cylinder, a first and second piston, a first and second connecting rod, and a crank shaft; wherein a cylinder head provides an opening between the first and second cylinder, wherein the cylinder head remains open to the first and second cylinders at all times; wherein the second connecting rod is offset from the first connecting rod at an offset angle between about 1 and about 90 degrees; wherein said first and second pistons reciprocate within said first and second cylinders and wherein said first and second pistons are connected to reciprocate together and maintain said offset angle while said pistons are reciprocating.

A method of modifying a conventional engine comprising the following steps: modifying or replacing a cylinder head to allow for at least two cylinders to communicate by connecting the cylinders via an opening disposed of above the top of the cylinders and below the cylinder head; and modifying or replacing at least one crankshaft on one of said at least two cylinders such that at least a connecting rod is connected to a piston that is disposed of in one cylinder and is offset from another connecting rod of another piston by an offset angle of between about 1 and about 90 degrees.

A system for modifying a standard engine comprising a replacement head having disposed of openings situated between a pair of cylinders on said standard engine, creating an opening between said pair of cylinders; and further comprising at least one replacement connecting rod for connecting a piston to a crankshaft, wherein said connecting rod situates said pair of cylinders such that the pair of cylinders is offset by between about 1 and 90 degrees.

### BRIEF DESCRIPTION OF THE DRAWINGS

FIG. 1 is a simplified schematic diagram of one embodiment of the invention described herein at the beginning of the intake stroke.

FIG. 2 is a simplified schematic diagram of one embodiment of the invention described herein at the end of the intake stroke.

FIG. 3 is a simplified schematic diagram of one embodiment of the invention described herein at the beginning of the compression stroke.

FIG. 4 is a simplified schematic diagram of one embodiment of the invention described herein at the end of the compression stroke.

FIG. 5 is a simplified schematic diagram of one embodiment of the invention described herein at the beginning of the power stroke.

FIG. 6 is a simplified schematic diagram of one embodiment of the invention described herein at the end of the power stroke.

FIG. 7 is a simplified schematic diagram of one embodiment of the invention described herein at the beginning of the exhaust stroke.

FIG. 8 is a simplified schematic diagram of one embodiment of the invention described herein at the end of the exhaust stroke.

FIGS. 9A and 9B are simplified schematic diagrams of additional embodiments of the invention described herein.

### DETAILED DESCRIPTION OF THE DRAWINGS

The embodiments of the invention and the various features and advantages thereto are more fully explained with references to the non-limiting embodiments and examples that are described and set forth in the following descriptions of those examples. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the claims.

As used herein, terms such as “a,” “an,” and “the” include singular and plural referents unless the context clearly demands otherwise.

As used herein, the term “about” means within 10% of a stated number.

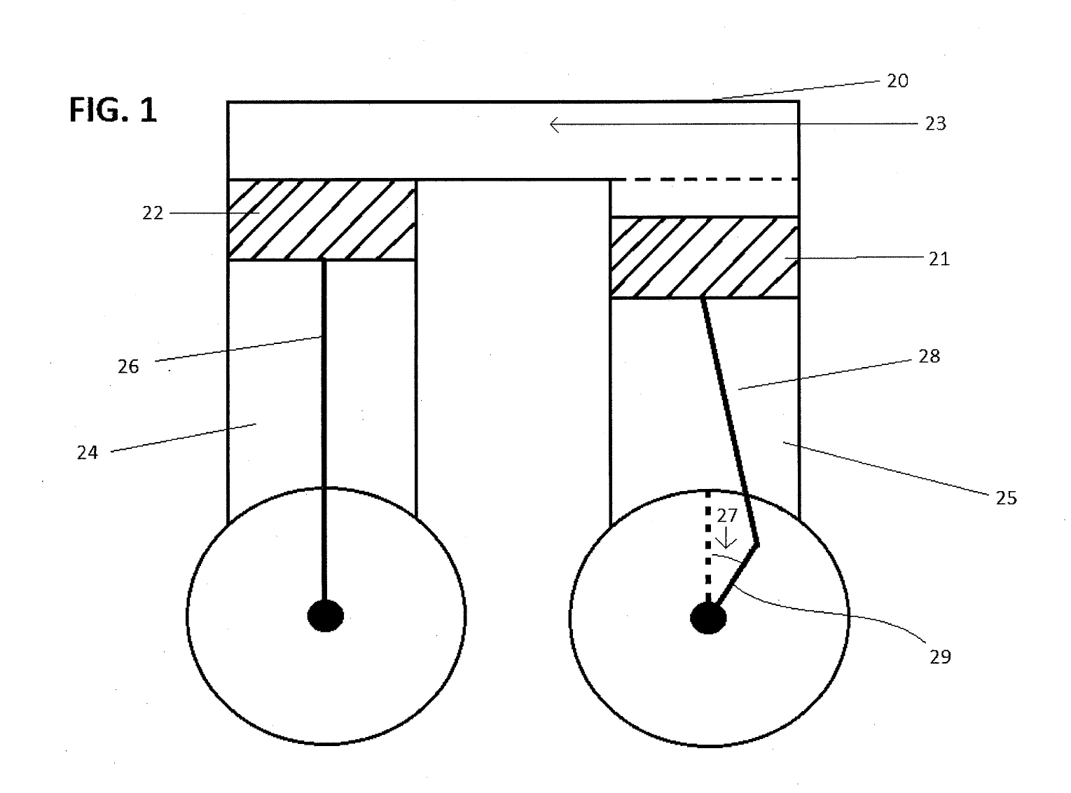

FIG. 1 is a simplified schematic diagram of one embodiment of the invention described herein at approximately the beginning of the intake stroke. The left piston 22 is located at approximately top dead center of the left cylinder 24, which is the point closest to the cylinder head 20. Thus, the left connecting rod 26 is approximately vertical.

The right piston 21 is offset from the left piston 22. When the left piston 22 is at top dead center, the angle 27 of offset of the right piston 21, as measured from where the right connecting rod 28 meets the crankshaft 29, is about 15 degrees offset the vertical position. In other words, the connecting rods of the two pistons are offset by about 15 degrees. Thus, the right connecting rod 28 is not completely vertical and the right piston 21 is after top dead center in the right cylinder 25.

The left piston 22 and right piston 21 are operated as a set of paired pistons/paired cylinders, such that the space in the head opening 23 connects the two cylinders 24 and 25. This head opening 23 provides that a single cycle is occurring within the two cylinders. One advantage of the system is that where a typical engine fires before top dead center, the force on the cylinder is wasted and inefficient. By pairing the two pistons/cylinders, the single explosion within the two cylinders will begin to affect at least one of the pistons as it is past top dead center, therefore allowing the full force of the explosion to push that piston, where the trailing piston is then pulled past top dead center, and then continues to push down due to the explosion.

Other embodiments of the invention provide that the angle 27 is offset by various amounts, between about 1 to about 90 degrees, or particularly from about 1 to about 45 degrees, or more particularly from about 10 to about 25 degrees. Alternatively, the angle 27 of offset may be from about 1 to about 5 degrees; from about 5 to about 10 degrees; from about 10 to about 20 degrees; about 30 to about 40 degrees; or about 40 to about 50 degrees. The angle of offset between the two pistons will depend on the size of the engine, the RPM's obtained and other features known to one of ordinary skill in the art. In the embodiment of FIG. 1, when the force from the explosion is applied to the pistons, the right piston 21 is at a mechanically superior position as compared to the left piston 22. This allows the force being applied to the right piston 21 to be mechanically efficient improves the mechanical efficiency as applied in total to the paired pistons, as compared to two individual pistons. By allowing one piston to always be past top dead center when firing, the combined mechanical efficiency is improved.

The pistons, upon firing, reciprocate in the cylinders, and go through the Otto cycle, so as to prepare the paired cylinders for firing.

By adjusting the offset angle 27, the compression in the head opening 23 can be modified to maximize performance of the engine. Similarly, the amount of space in the head opening 23 can be modified to enlarge or minimize the opening space to modify the amount of possible compression. However, in the embodiment of FIG. 1, at no time is the head opening 23 closed; therefore, the two cylinders/pistons are always connected via this head opening 23 space.

FIG. 1 corresponds to one pair of cylinders, 24, 25, whereby the pistons 21, 22, able to reciprocate within those cylinders, are attached together to move such that the offset angle 27 is maintained. Generally, a functioning engine would comprise a single pair of cylinders, or, alternatively, two, three, or four pairs, or more pairs of cylinders to maintain balance. The additional cylinders may be oriented in-line, or offset in any of the orientations known of one of skill in the art.

It would be feasible to take a straight 8 cylinder, or an angled 8 cylinder engine and modify various components of the engine, i.e. the cylinder head 20, so as to introduce a head opening 23, as between the previously unconnected cylinders. With additional modifications to the connecting rods 26 and 28 and other features of the engine to form the offset paired cylinders. Indeed, by having an engine with 8 cylinders, each of the four pairs could be starting one of the four cycles of the Otto cycle, as a mechanism to balance the engine and optimize the efficiency.

Similarly, a four cylinder engine could have one pair beginning the firing cycle and the other beginning the intake cycle. Alternatively, it may be advantageous to have each pair offset as to another pair of cylinders.

This design of this embodiment differs significantly from other designs in which two pistons are pushed from a single explosion via the opposing cylinder engine. There, the pistons fire in opposing directions. Here, the cylinders are intended to be substantially parallel to one another, but the pistons within the cylinders are offset. That allows for the modification in the head to allow for the connection of the two cylinders.

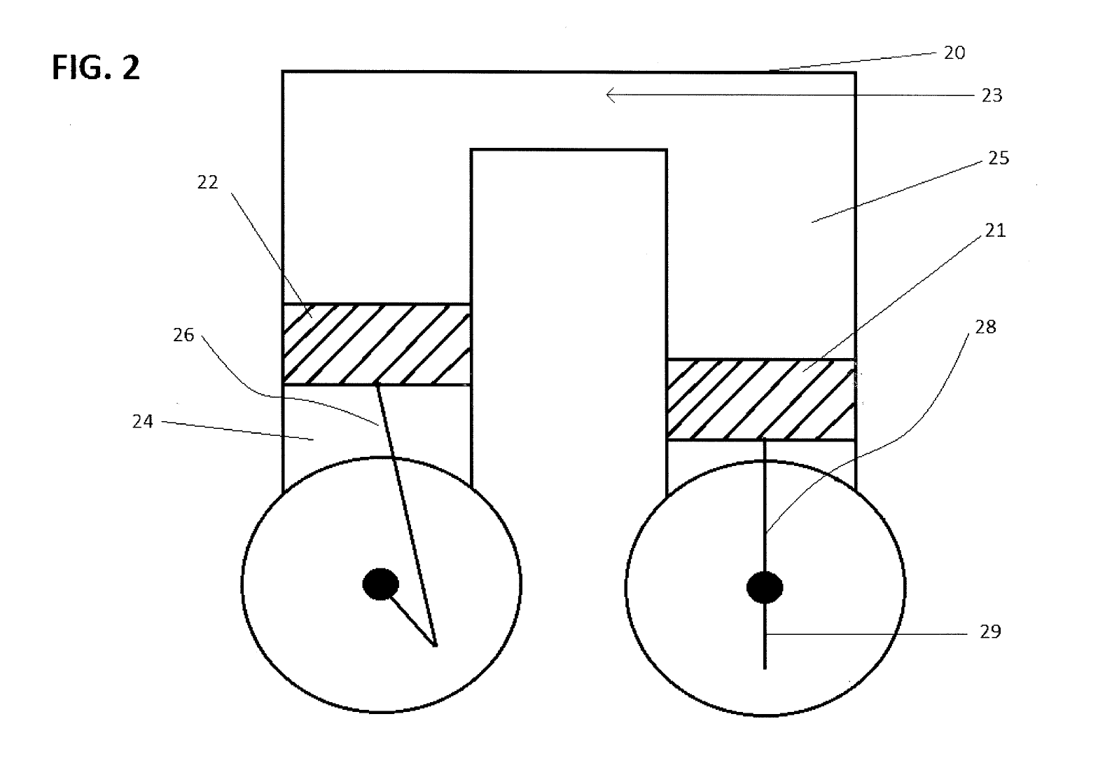

FIG. 2 is a simplified schematic diagram of one embodiment of the invention described herein at approximately the end of the intake stroke. The right piston 21 is located at approximately bottom dead center of the right cylinder 25, which is the point farthest from the cylinder head 20. The left piston 22 is offset from the right piston 21 such that the left piston 22 is before bottom dead center in the left cylinder 24.

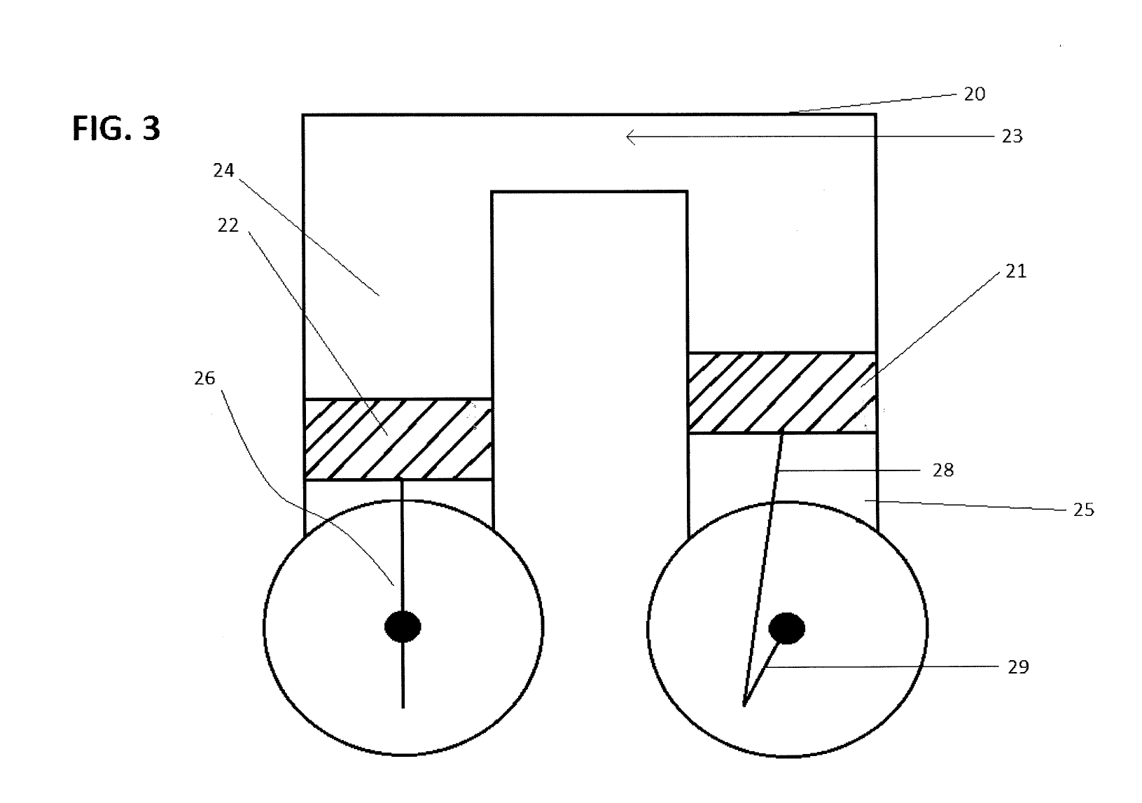

FIG. 3 is a simplified schematic diagram of one embodiment of the invention described herein at approximately the beginning of the compression stroke. The left piston 22 is located at approximately bottom dead center of the left cylinder 24, which is the farthest point from the cylinder head 20. The right piston 21 is offset from the left piston 22 such that the right piston 21 is after bottom dead center in the right cylinder 25.

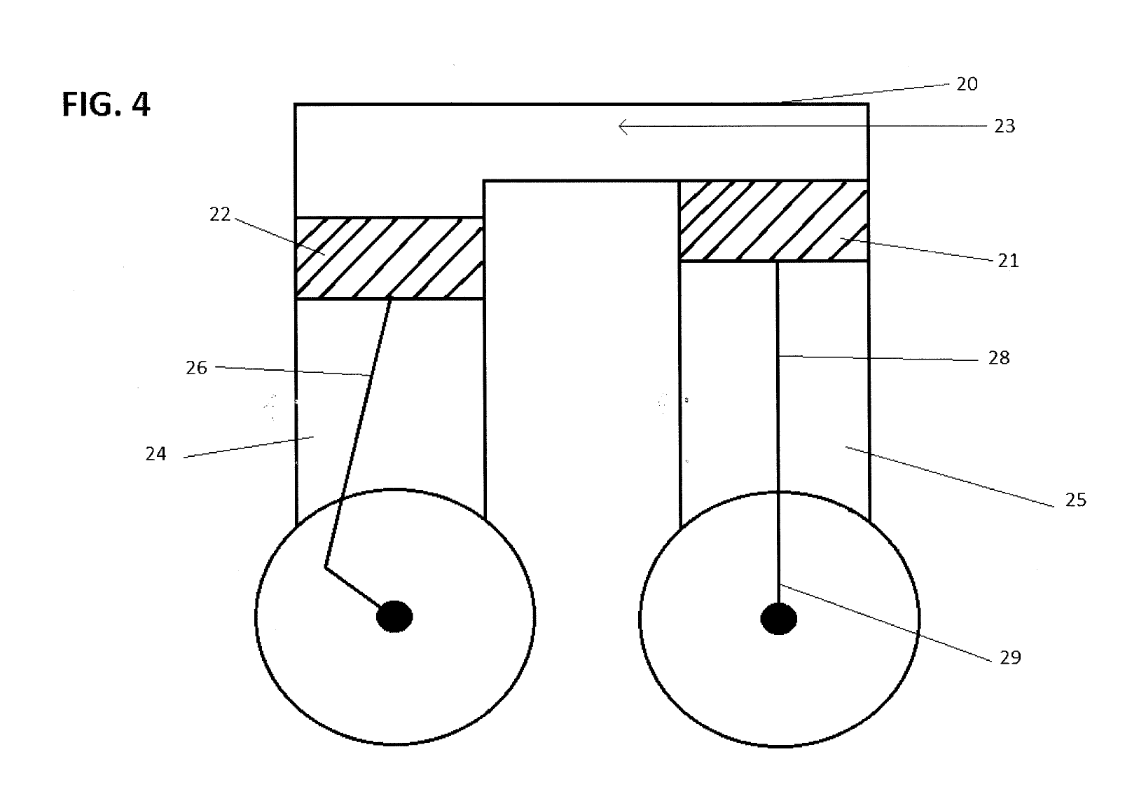

FIG. 4 is a simplified schematic diagram of one embodiment of the invention described herein at approximately the end of the compression stroke. The right piston 21 is located at approximately top dead center of the right cylinder 25, which is the closest point to the cylinder head 20. The left piston 22 is offset from the right piston 21 such that the left piston 22 is before top dead center in the left cylinder 24.

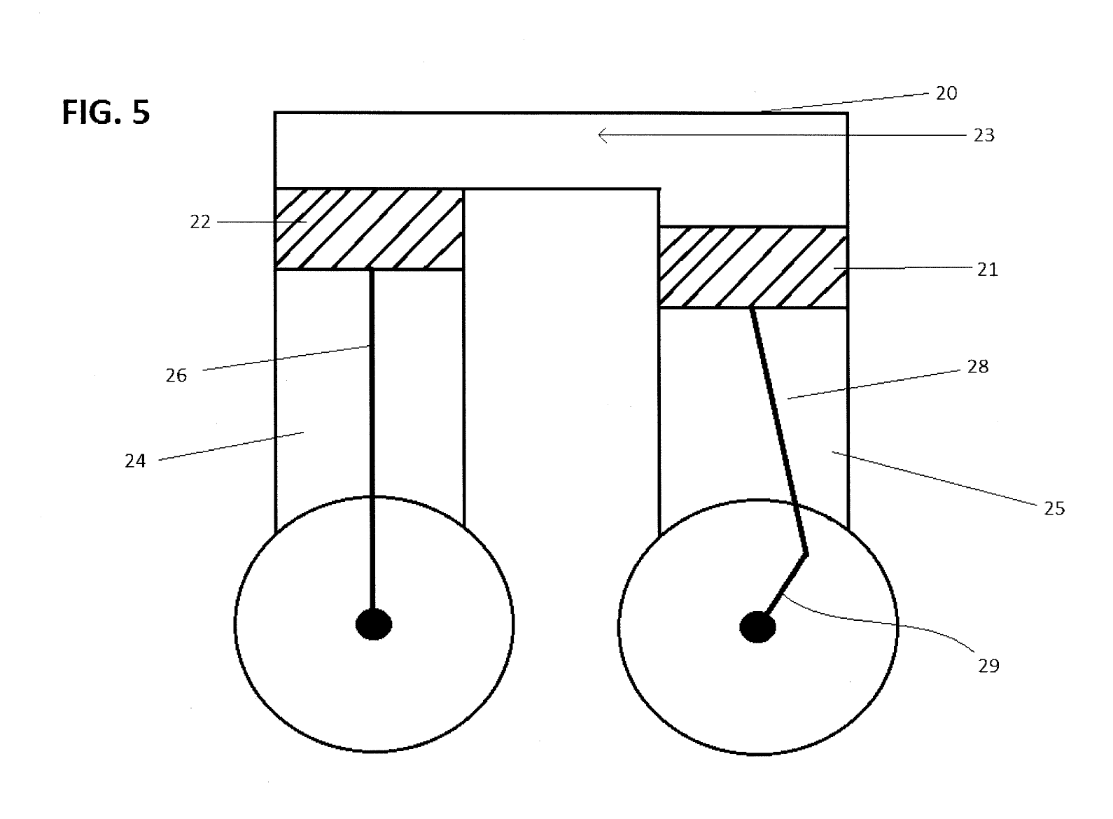

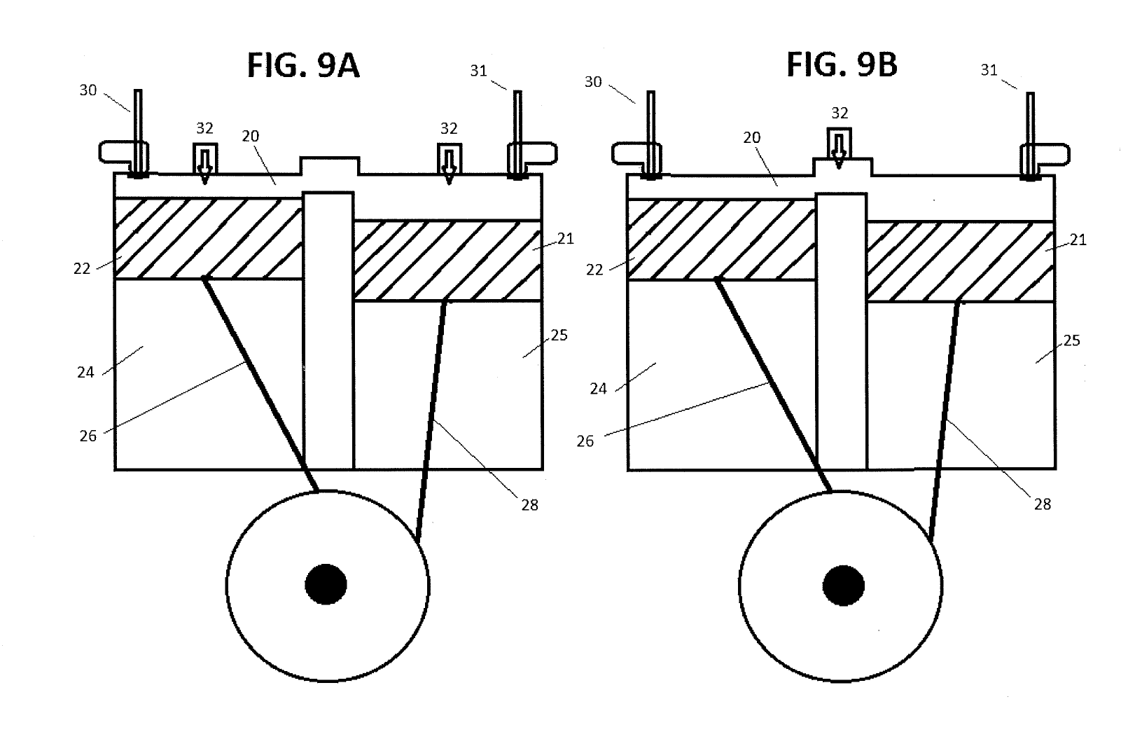

FIG. 5 is a simplified schematic diagram of one embodiment of the invention described herein at approximately the beginning of the power stroke, or approximately the moment of ignition. Both spark ignition and compression ignition engines are contemplated by embodiments of the current invention. In embodiments utilizing spark ignition, one or more spark plugs can be located in various positions, as exemplified by FIGS. 9A and 9B. At the approximate beginning of the power stroke, the left piston 22 is located at approximately top dead center of the left cylinder 24, which is the closest point to the cylinder head 20. The right piston 21 is offset from the left piston 22 such that the right piston 21 is after top dead center in the right cylinder 25.

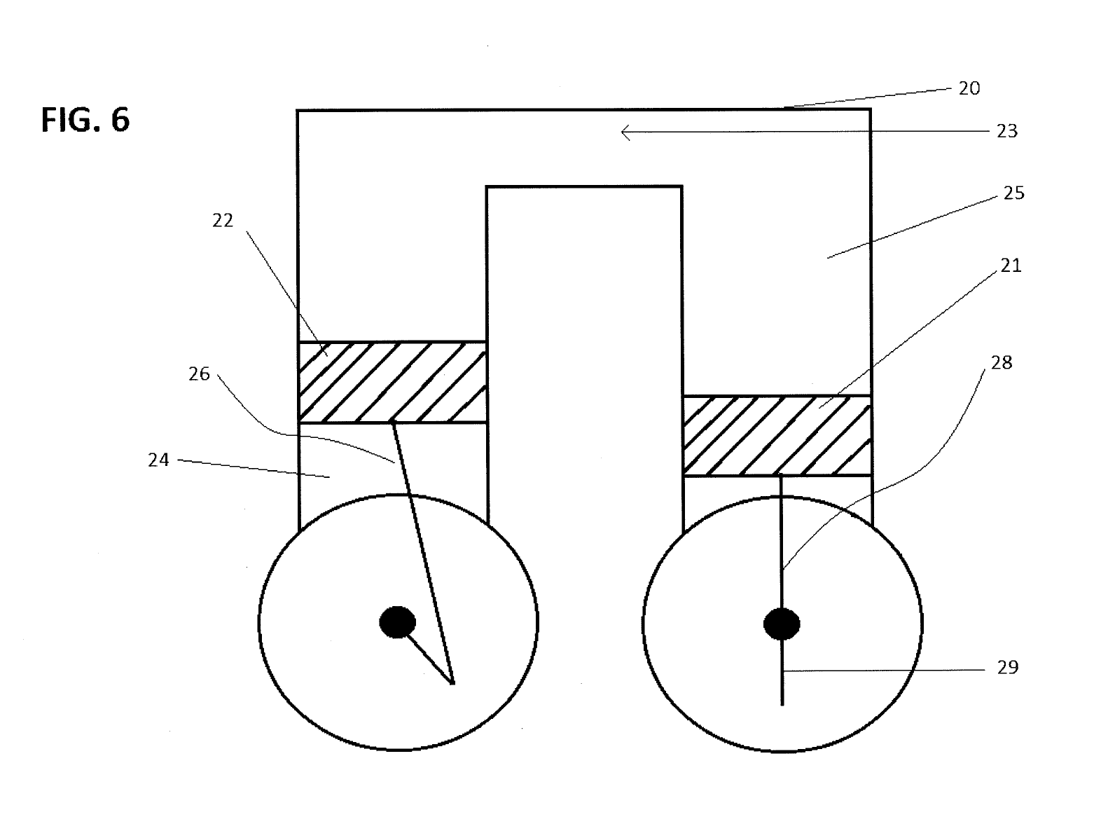

FIG. 6 is a simplified schematic diagram of one embodiment of the invention described herein at approximately the end of the power stroke. The right piston 21 is located at approximately bottom dead center of the right cylinder 25, which is the farthest point from the cylinder head 20. The left piston 22 is offset from the right piston 21 such that the left piston 22 is before bottom dead center in the left cylinder 24.

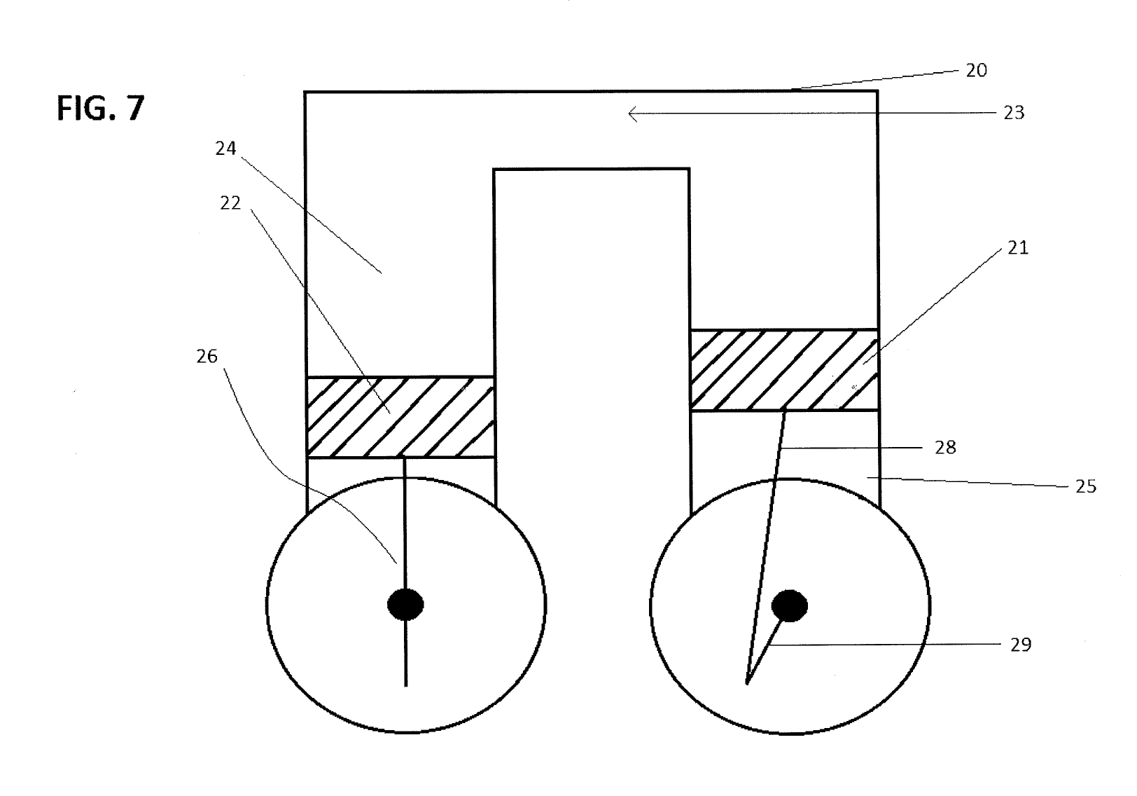

FIG. 7 is a simplified schematic diagram of one embodiment of the invention described herein at approximately the beginning of the exhaust stroke. The left piston 22 is located at approximately bottom dead center of the left cylinder 24, which is the farthest point from the cylinder head 20. The right piston 21 is offset from the left piston 22 such that the right piston 21 is after bottom dead center in the right cylinder 25.

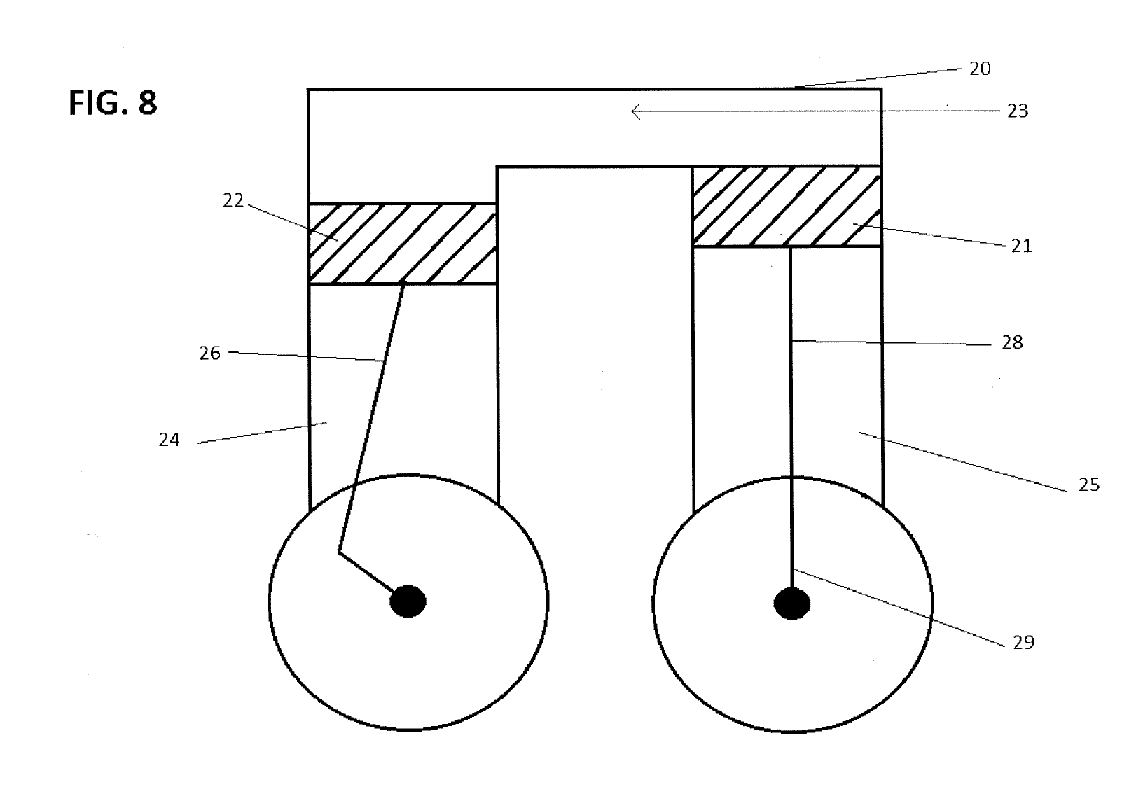

FIG. 8 is a simplified schematic diagram of one embodiment of the invention described herein at approximately the end of the exhaust stroke. The right piston 21 is located at approximately top dead center of the right cylinder 25, which is the closest point to the cylinder head 20. The left piston 22 is offset from the right piston 21 such that the left piston 22 is before top dead center in the left cylinder 24.

FIGS. 9A and 9B are simplified schematic diagrams of embodiments of the invention described herein. These figures include the inlet valve 30 and outlet valve 31 that control the flow of reactants into and out of the cylinder head 20, respectively. In FIG. 9A, there are two spark plugs 32, one above the left cylinder 24, and the other above the right cylinder 25. As is known to one of skill in the art, the valves allow for control of fluids and combusted fluids and gases to be exchanged from the cylinder to allow for the next combustion cycle.

In FIG. 9B, there is only one spark plug 32, located between the two cylinders 24, 25. Alternatively, the singular spark plug 32 could be located above the left cylinder 24 or the right cylinder 25. More or less valves/spark plugs are also contemplated in the invention and can be utilized with each set of paired cylinders. For example, where there is an eight cylinder engine, four pairs of cylinders could be paired by four or eight spark plugs. The use of more or less spark plugs is customizable based on the amount of fuel to be ignited and the compression within the cylinder.

A particular feature of the invention is that a replacement head and replacement connecting rods are relatively inexpensive to manufacture and can be modified on an existing engine to create a modified paired cylinder engine as described in the various embodiments herein. Accordingly, a further embodiment of the invention is a kit or a system comprising a modified head having disposed openings that are situated between a pair of cylinders, and further comprising one or more replacement connecting rods to augment the angle of at least one piston in the engine, so as to pair the cylinders and create an offset angle of between 1 and 90 degrees between the paired cylinders. In some applications, a replacement crankshaft may be necessary to create further efficiencies with the replacement crankshafts. The result of the system is a kit that can be utilized with a standard engine to modify it to having paired cylinders. No other similar system or kit currently exists.

Although the present invention has been described in considerable detail, those skilled in the art will appreciate that numerous changes and modifications may be made to the embodiments and preferred embodiments of the invention and that such changes and modifications may be made without departing from the spirit of the invention. It is therefore intended that the appended claims cover all equivalent variations as fall within the scope of the invention.

What is claimed is:

1. An internal combustion engine comprising:
a cylinder head, a first and second cylinder, a first and second piston, a first and second connecting rod, and a crank shaft,
wherein the first and second cylinder communicate via the cylinder head,
wherein the cylinder head remains open to the first and second cylinders at all times, and
wherein the second connecting rod is offset from the first connecting rod at an offset angle between about 1 and about 90 degrees.

2. The internal combustion engine of claim 1, wherein the offset angle is between about 1 and about 45 degrees.

3. The internal combustion engine of claim 1, wherein the offset angle is between about 10 and about 25 degrees.

4. The internal combustion engine of claim 1, wherein the offset angle is between about 1 and about 5 degrees.

5. The internal combustion engine of claim 1, wherein the offset angle is between about 5 and about 10 degrees.

6. The internal combustion engine of claim 1, wherein the offset angle is between about 10 and about 20 degrees.

7. The internal combustion engine of claim 1, wherein the offset angle is between about 20 and about 30 degrees.

8. The internal combustion engine of claim 1, wherein the offset angle is between about 30 and about 40 degrees.

9. The internal combustion engine of claim 1, wherein the offset angle is between about 40 and about 50 degrees.

10. The internal combustion engine of claim 1, wherein the first and second cylinder are powered by a common source.

11. The internal combustion engine of claim 1, wherein combustion occurs via ignition combustion.

12. The internal combustion engine of claim 1, wherein combustion occurs via compression combustion.

13. The internal combustion engine of claim 1, wherein the internal combustion engine is capable of being modified to or from a conventional engine by replacing or altering the cylinder head and at least one crankshaft.

14. The internal combustion engine of claim 1, wherein ignition occurs when the first piston is at top dead center.

15. The internal combustion engine of claim 1, wherein ignition occurs when the second piston is after top dead center.

16. An internal combustion engine comprising:
a cylinder head, a first and second cylinder, a first and second piston, a first and second connecting rod, and a crank shaft;
wherein a cylinder head provides an opening between said first and second cylinders;
wherein the cylinder head remains open to the first and second cylinders at all times;
wherein the second connecting rod is offset from the first connecting rod at an offset angle between about 1 and about 90 degrees;
wherein said first and second pistons reciprocate within said first and second cylinders;
and wherein said first and second pistons are connected to reciprocate together and maintain said offset angle while said pistons are reciprocating.

17. The internal combustion engine of claim 16, wherein the internal combustion engine is capable of being modified to or from a conventional engine by replacing or altering the cylinder head and at least one crankshaft.

18. A method of modifying a conventional engine comprising the following steps:
a. modifying or replacing a cylinder head to allow for at least two cylinders to communicate by connecting the cylinders via an opening disposed of above the top of the cylinders and below the cylinder head; and
b. modifying or replacing at least one crankshaft on one of said at least two cylinders such that at least a connecting rod is connected to a piston that is disposed of in one cylinder and is offset from another connecting rod of another piston by an offset angle of between about 1 and about 90 degrees.

19. The method of claim 18, wherein the second step is applied to each communicating pair of cylinders such that each communicating pair includes a first connecting rod of a first piston that is offset from a second connecting rod of a second piston by an offset angle of between about 1 and about 90 degrees.

20. The method of claim 18, wherein the second step is applied to each communicating pair of cylinders such that each communicating pair includes a first connecting rod of a first piston that is offset from a second connecting rod of a second piston by an offset angle of between about 1 and about 45 degrees.
